(19) United States
(12) Patent Application Publication
(10) Pub. No.: US 2026/0024368 A1
(43) Pub. Date: Jan. 22, 2026

(54) Automated Invoice Coding System for Accounts Payable

(71) Applicants: Jacob Høy Berthelsen, Højbjerg (DK); Bo Thiesson, Aarhus (DK); Mads Ellersgaard Kalør, Aarhus (DK); Mads Kristensen, Egå (DK); Nikolaj Stenvang Hansen, Risskov (DK)

(72) Inventors: Jacob Høy Berthelsen, Højbjerg (DK); Bo Thiesson, Aarhus (DK); Mads Ellersgaard Kalør, Aarhus (DK); Mads Kristensen, Egå (DK); Nikolaj Stenvang Hansen, Risskov (DK)

(21) Appl. No.: 18/773,747

(22) Filed: Jul. 16, 2024

(51) Int. Cl. G06V 30/414; G06V 30/12; G06V 30/19

(52) U.S. Cl. CPC G06V 30/414; G06V 30/133; G06V 30/1916

(57) ABSTRACT

An automated invoice coding system for accounts payable is disclosed, comprising a data extraction module, an artificial intelligence (AI) engine with at least one machine learning model, a data processing module, a user interface module, an integration module, and a continuous learning module. The data extraction module extracts data from invoices, and the AI engine processes this data to generate coding predictions for accounting dimensions. The data processing module validates these predictions, while the user interface module displays them for user review and correction. The integration module transmits the validated coding predictions to the accounts payable system. The continuous learning module updates the AI model with new data, ensuring ongoing accuracy. The system operates autonomously without predefined rules or templates, providing real-time coding predictions.

### FIELD OF INVENTION

The present invention relates generally to the field of financial technology, specifically to systems and methods for automating the coding of invoices in accounts payable processes using artificial intelligence.

### BACKGROUND

The current landscape of accounts payable (AP) systems reveals several limitations and inefficiencies inherent in traditional methods. Existing systems predominantly rely on predefined rules, templates, or mappings for coding invoices. These methods necessitate significant manual intervention and frequent updates to the ruleset, which can lead to operational bottlenecks and errors. The manual data entry and validation processes are not only time-consuming but also susceptible to human error, contributing to financial discrepancies and delayed payments.

Moreover, traditional AP systems often struggle with scalability. As transaction volumes increase, the performance of these systems tends to degrade, resulting in slower processing times and further delays in the payment cycle. This issue is compounded by the rigidity of predefined rules and templates, which are not easily adaptable to new or changing invoice formats and accounting standards.

Another significant drawback is the lack of real-time data processing. Conventional systems typically operate in batch modes, processing invoices in bulk at scheduled intervals. This delay prevents timely updates and hinders the ability to make real-time financial decisions. Consequently, companies may miss out on early payment discounts and incur additional costs due to late payments.

The integration of these traditional systems with modern Enterprise Resource Planning (ERP) and other financial management systems also poses challenges. The compatibility issues often result in fragmented data flows, necessitating additional layers of manual reconciliation and data verification. This fragmentation further exacerbates inefficiencies and increases the risk of errors.

Additionally, currently available systems do not effectively leverage advanced technologies such as artificial intelligence and machine learning. These technologies have the potential to revolutionize data extraction and coding processes by learning from historical data and improving accuracy over time. However, the existing systems' reliance on static rules and templates means they are unable to take advantage of these advancements, limiting their ability to evolve and improve.

The need for a more dynamic, scalable, and intelligent solution in the AP domain is evident. There is a growing demand for systems that can autonomously adapt to new data, provide real-time processing capabilities, and ly integrate with various financial platforms to enhance overall efficiency and accuracy.

It is within this context that the present invention is provided.

### SUMMARY

The present invention relates to a system and method for automating the coding of invoices in an accounts payable system. The system includes a data extraction module, an artificial intelligence (AI) engine, a data processing module, a user interface module, an integration module, and a continuous learning module. This system operates autonomously from predefined rules or templates and provides real-time coding predictions upon receipt of an invoice. The invention offers increased efficiency, reduced manual data entry, and improved accuracy in coding invoices.

In some embodiments, the accounting dimensions include general ledger accounts, cost centers, and approvers, ensuring comprehensive categorization of financial data.

In further embodiments, the data extraction module utilizes optical character recognition (OCR) technology to extract data from invoices, handling both electronic and scanned paper invoices. This feature enables the system to process a wide variety of invoice formats efficiently.

In yet further embodiments, the AI engine comprises a plurality of machine learning models, including deep learning models and tree-based models, and includes natural language processing (NLP) capabilities to interpret the contextual meaning of the extracted data. This combination enhances the accuracy and reliability of coding predictions.

In some embodiments, the data processing module is configured to enrich the coding predictions with additional information relevant to the accounting dimensions and performs validation checks to ensure data completeness and consistency before processing. This ensures the integrity and accuracy of the coded data.

In further embodiments, the user interface module allows users to review and correct the coding predictions before they are transmitted to the accounts payable system. It also supports multi-user access with role-based permissions for viewing and editing coding predictions. This provides flexibility and control over the coding process.

In yet further embodiments, the continuous learning module updates the machine learning model of the AI engine with new invoice data to enhance accuracy and adapt to changing conditions over time, employing online learning techniques to incrementally update the machine learning model. This continuous improvement mechanism ensures the system remains effective and up-to-date.

In some embodiments, the integration module is configured to interface with various financial management systems, including Enterprise Resource Planning (ERP) systems, and supports secure data exchange protocols to ensure data integrity and confidentiality during transmission. This facilitates integration with existing financial infrastructure.

In further embodiments, the integration module includes Application Programming Interfaces (APIs) for integration with external systems and is configured to handle large volumes of invoices and transactions without degradation in performance. This scalability feature makes the system suitable for high-volume environments.

In yet further embodiments, the user interface module provides real-time feedback on the status of the invoice coding process and includes an audit trail feature to track changes made by users to the coding predictions. This transparency and accountability feature supports audit and compliance requirements.

In some embodiments, the AI engine provides confidence scores for the coding predictions to assist users in reviewing the predictions. This feature helps users gauge the reliability of the automated coding.

In further embodiments, the system supports cloud-based deployment for scalability and ease of access, allowing users to benefit from flexible and scalable infrastructure.

In yet further embodiments, the data extraction module can integrate with external OCR service providers to enhance data extraction capabilities. This flexibility ensures that the system can leverage the best available technologies for data extraction.

### BRIEF DESCRIPTION OF THE DRAWINGS

Various embodiments of the invention are disclosed in the following detailed description and accompanying drawings.

FIG. 1 illustrates an example system architecture for the automated invoice coding system implemented on a web server and database.

FIG. 2 illustrates an example computer-implemented method steps in a workflow for processing and coding invoices using the automated invoice coding system.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The term “data extraction module” refers to any software or hardware component designed to receive and extract data from invoices. This includes, but is not limited to, optical character recognition (OCR) systems, digital scanning devices, and software algorithms that parse digital invoice files. In one example implementation, the data extraction module employs enhanced OCR technology to accurately digitize both printed and handwritten invoice details, converting them into machine-readable data for further processing.

The term “artificial intelligence (AI) engine” refers to a computational system comprising one or more machine learning models trained on historical invoice data. This includes, but is not limited to, deep learning neural networks, tree-based models, and natural language processing (NLP) algorithms. In one example implementation, the AI engine uses a combination of these models to analyze extracted invoice data and generate coding predictions for various accounting dimensions such as general ledger accounts and cost centers.

The term “data processing module” refers to any software or hardware component that validates and enriches the coding predictions generated by the AI engine. This includes, but is not limited to, algorithms for data validation, enrichment processes that add relevant information, and error-checking mechanisms. In one example implementation, the data processing module cross-references the AI-generated predictions with existing financial records to ensure accuracy and completeness before the data is transmitted to the accounts payable system.

The term “user interface module” refers to any software or hardware component that allows users to interact with the system, review, and correct coding predictions. This includes, but is not limited to, graphical user interfaces (GUIs), mobile applications, and command-line interfaces. In one example implementation, the user interface module provides a web-based dashboard where users can view real-time coding predictions, make necessary adjustments, and submit final approvals.

The term “integration module” refers to any software or hardware component designed to interface with the accounts payable system and other external systems. This includes, but is not limited to, Application Programming Interfaces (APIs), middleware, and data exchange protocols. In one example implementation, the integration module uses secure APIs to facilitate data transmission between the automated invoice coding system and various Enterprise Resource Planning (ERP) systems.

The term “continuous learning module” refers to any software or hardware component that updates the machine learning models of the AI engine with new data. This includes, but is not limited to, online learning techniques, batch updates, and feedback loops from user corrections. In one example implementation, the continuous learning module periodically retrains the AI models using the latest invoice data and user feedback to improve accuracy and adapt to changing invoice formats and accounting standards.

The term “accounting dimensions” refers to the various categories and classifications used in financial accounting to organize and track financial data. This includes, but is not limited to, general ledger accounts, cost centers, and approvers. In one example implementation, the AI engine generates coding predictions for these accounting dimensions, ensuring that each invoice is accurately categorized according to the company's financial structure.

### DESCRIPTION OF DRAWINGS

The present invention relates to a system and method for automating the coding of invoices in accounts payable processes using artificial intelligence. The invention addresses the significant limitations of traditional accounts payable systems, which rely heavily on predefined rules, templates, and manual data entry. These conventional methods are not only labor-intensive and prone to errors, but they also lack scalability and the ability to adapt to new and changing invoice formats.

The automated invoice coding system of the present invention comprises several interconnected modules that work together to streamline and enhance the efficiency of the accounts payable process. The data extraction module is designed to receive and extract data from invoices using advanced optical character recognition (OCR) technology. This module is capable of handling both electronic and scanned paper invoices, ensuring broad applicability across different invoice formats.

The core of the system is the artificial intelligence (AI) engine, which includes one or more machine learning models trained on historical invoice data. Unlike traditional systems that depend on static rules and templates, the AI engine processes the extracted data and generates coding predictions autonomously. These predictions cover various accounting dimensions such as general ledger accounts, cost centers, and approvers, providing a comprehensive solution for invoice coding.

To ensure the accuracy and reliability of the coding predictions, the data processing module validates and enriches the predictions generated by the AI engine. This module incorporates additional information relevant to the accounting dimensions and performs thorough validation checks, thereby mitigating errors and enhancing data integrity.

The user interface module allows users to interact with the system, review coding predictions, and make any necessary corrections. This module supports multi-user access with role-based permissions, providing flexibility and control over the coding process. Users can view real-time feedback on the status of invoice coding and utilize an audit trail feature to track changes and ensure compliance with audit requirements

The integration module facilitates communication between the automated invoice coding system and various external systems, including Enterprise Resource Planning (ERP) systems. This module uses secure Application Programming Interfaces (APIs) and supports large volumes of invoices and transactions without performance degradation, making it suitable for high-volume environments.

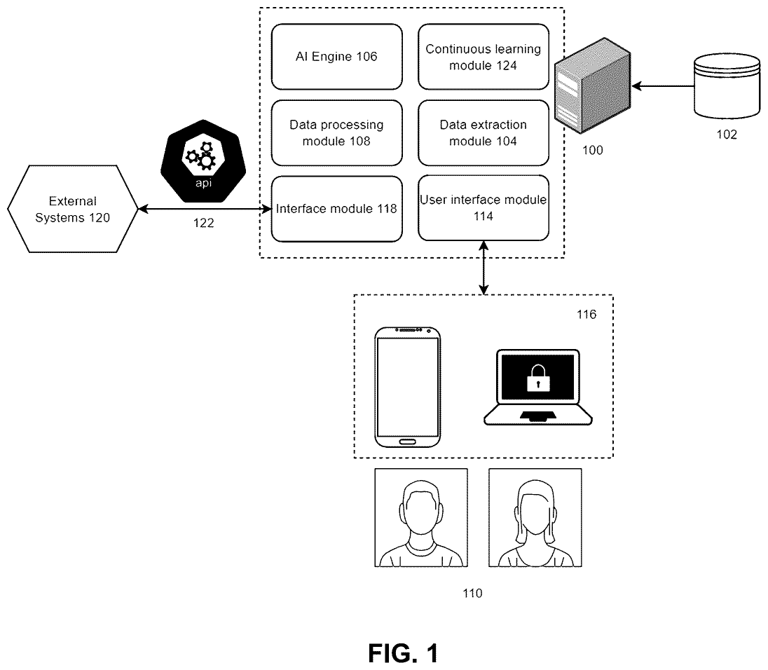

Referring now to the drawings, FIG. 1 illustrates the system architecture for an example embodiment of the automated invoice coding system implemented on a web server and database.

The central component of the system is the web server 100, which hosts the various modules and handles communication between different parts of the system. Connected to the web server is the database 102, which stores historical invoice data, user information, and machine learning models, essential for providing the AI engine with the necessary data to generate coding predictions and for storing continuously updated models.

The data extraction module 104 is integrated into the web server and is responsible for receiving invoices from various sources. These invoices can be in electronic form or scanned paper documents. The data extraction module uses advanced optical character recognition (OCR) technology to extract relevant data from the invoices, converting it into machine-readable format. This extracted data is then forwarded to the AI engine 106.

The AI engine 106, which comprises one or more machine learning models trained on historical invoice data stored in the database, processes the extracted data to generate coding predictions for various accounting dimensions. These dimensions include general ledger accounts, cost centers, and approvers. The AI engine operates autonomously without relying on predefined rules or templates, providing accurate coding predictions from the start.

To ensure the accuracy and reliability of the coding predictions, the data processing module 108 validates and enriches the predictions generated by the AI engine. This module cross-references the predictions with existing financial records to ensure their accuracy and completeness before they are finalized. For example, during the bills workflow, once a bill is received from the supplier and imported into the accounting system, the data is enriched and validated before creating a posting in the accounting system, as depicted in the document.

Users 110 interact with the system via the user interface module 114, which is accessible through various user devices 116 such as desktop computers, laptops, tablets, and smartphones. The user interface module 114 allows users to review and correct coding predictions if necessary. It supports multi-user access with role-based permissions, providing flexibility and control over the coding process. Users can view real-time feedback on the status of invoice coding and utilize an audit trail feature to track changes and ensure compliance with audit requirements.

The integration module 118 facilitates communication between the automated invoice coding system and external systems 120 such as Enterprise Resource Planning (ERP) systems. This module uses secure Application Programming Interfaces (APIs) 122 to transmit validated coding predictions to accounts payable systems of external parties and other financial management platforms, ensuring accurate general ledger entries and bank statement entries.

The system also includes a continuous learning module 124, which updates the machine learning models with new invoice data and user feedback. This module employs online learning techniques to incrementally improve the accuracy of the AI engine. The continuous learning module ensures that the system adapts to new data and changing invoice formats over time.

The system also includes security measures to protect data integrity and confidentiality during transmission between the user devices and the web server, as well as between the web server and external systems. These measures include encryption protocols and secure authentication methods to ensure that only authorized users can access the system.

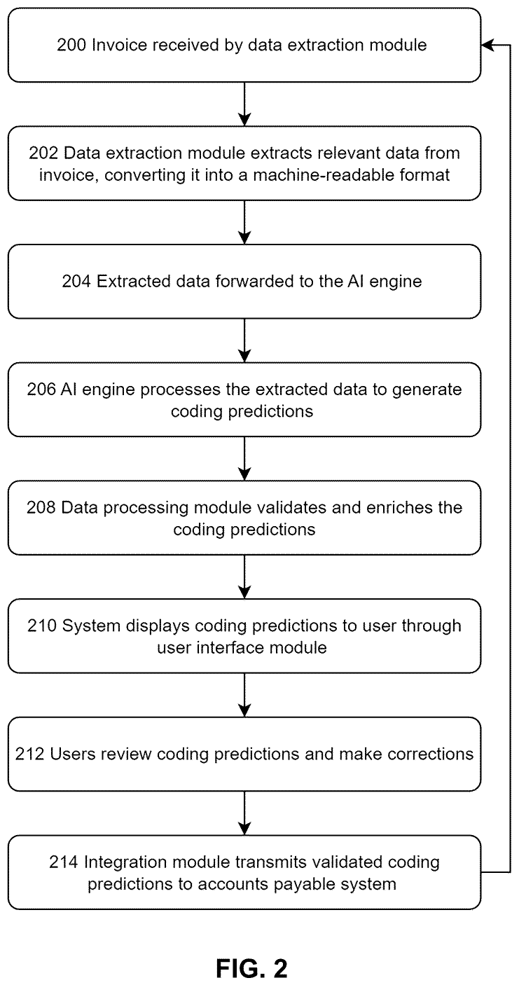

FIG. 2 illustrates the computer-implemented method steps in an example workflow for the automated invoice coding system. This method, implemented on the architecture described in FIG. 1, outlines the sequence of operations performed by the system to process invoices and generate coding predictions.

The method begins at step 200, where an invoice is received by the data extraction module 104. The invoice 106 can be in electronic form or a scanned paper document. At step 202, the data extraction module utilizes advanced optical character recognition (OCR) technology 108 to extract relevant data from the invoice, converting it into a machine-readable format.

In step 204, the extracted data is forwarded to the AI engine 110. The AI engine, comprising one or more machine learning models trained on historical invoice data, processes the extracted data at step 206 to generate coding predictions 112. These predictions cover various accounting dimensions, including general ledger accounts, cost centers, and approvers.

At step 208, the data processing module 114 validates and enriches the coding predictions. This involves cross-referencing the AI-generated predictions with existing financial records to ensure their accuracy and completeness. For example, as detailed in the bills workflow from the provided document, data from the bill, such as the amount and supplier items, is enriched and validated before being processed further.

Once the predictions are validated, step 210 involves displaying the coding predictions to users through the user interface module 116. Users access this interface via various user devices 118, such as desktop computers, laptops, tablets, and smartphones. At step 212, users review the coding predictions and, if necessary, make corrections. The user interface module supports multi-user access with role-based permissions, enabling different levels of interaction based on the user's role within the organization.

In step 214, the integration module 120 transmits the validated and corrected coding predictions to the accounts payable system and other external systems. This is achieved through secure Application Programming Interfaces (APIs) 124. For instance, as outlined in the provided workflows, the integration module posts invoices and payments to the accounting system, creating general ledger entries and initiating bank statement entries.

Throughout the process, the continuous learning module 126 updates the machine learning models of the AI engine with new invoice data and feedback from user corrections. This continuous learning process employs online learning techniques to incrementally improve the accuracy of the AI models, ensuring that the system adapts to new data and changing invoice formats over time.

The entire process is recorded and audited the to ensure compliance and transparency. The user interface module may include an audit trail feature that tracks changes made by users, providing a comprehensive record of the invoice processing and coding activities.

### Controller/Processor Components

A server as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for automating the coding of invoices in an accounts payable system, comprising:
a data extraction module configured to receive and extract data from invoices;
an artificial intelligence (AI) engine, operatively coupled to the data extraction module, comprising at least one machine learning model, wherein the AI engine is configured to process the extracted data and generate coding predictions for accounting dimensions;
a data processing module configured to validate the coding predictions generated by the AI engine;
a user interface module configured to display the coding predictions to a user and receive user input;
an integration module configured to interface with an accounts payable system and other external systems, the integration module being adapted to transmit the validated coding predictions to the accounts payable system;
a continuous learning module configured to update the machine learning model of the AI engine with new data.

2. The system of claim 1, wherein the accounting dimensions include at least general ledger accounts, cost centers, and approvers.

3. The system of claim 1, wherein the data extraction module utilizes optical character recognition (OCR) technology to extract data from invoices, and is configured to handle both electronic and scanned paper invoices.

4. The system of claim 1, wherein the AI engine comprises a plurality of machine learning models, including deep learning models and tree-based models, and includes natural language processing (NLP) capabilities to interpret the contextual meaning of the extracted data.

5. The system of claim 1, wherein the data processing module is further configured to enrich the coding predictions with additional information relevant to the accounting dimensions, and performs validation checks to ensure the completeness and consistency of the extracted data before processing.

6. The system of claim 1, wherein the user interface module allows users to review and correct the coding predictions before they are transmitted to the accounts payable system, and supports multi-user access with role-based permissions for viewing and editing coding predictions.

7. The system of claim 1, wherein the continuous learning module updates the machine learning model of the AI engine with new invoice data to enhance accuracy and adapt to changing conditions over time, and employs online learning techniques to incrementally update the machine learning model.

8. The system of claim 1, wherein the integration module is configured to interface with various financial management systems, including Enterprise Resource Planning (ERP) systems, and supports secure data exchange protocols to ensure data integrity and confidentiality during transmission.

9. The system of claim 1, wherein the integration module includes Application Programming Interfaces (APIs) for integration with external systems, and is configured to handle large volumes of invoices and transactions without degradation in performance.

10. The system of claim 1, wherein the user interface module provides real-time feedback on the status of the invoice coding process, and includes an audit trail feature to track changes made by users to the coding predictions.

11. The system of claim 1, wherein the AI engine is configured to generate coding predictions without relying on predefined rules or templates, and makes coding predictions for multiple line items within a single invoice.

12. The system of claim 1, wherein the data extraction module uses machine learning models to improve the accuracy of OCR over time, and can integrate with external OCR service providers to enhance data extraction capabilities.

13. The system of claim 1, wherein the continuous learning module collects feedback from user corrections to further train and improve the machine learning models.

14. The system of claim 1, wherein the AI engine provides confidence scores for the coding predictions to assist users in reviewing the predictions.

15. The system of claim 1, wherein the system supports cloud-based deployment for scalability and ease of access.

16. The system of claim 1, wherein the data processing module performs validation checks to ensure data completeness and consistency before processing, and enriches the coding predictions with relevant information.

17. The system of claim 1, wherein the AI engine includes a plurality of machine learning models and natural language processing capabilities to interpret contextual data.

18. The system of claim 1, wherein the user interface module allows for multi-user access with role-based permissions and provides real-time feedback on coding status.

19. The system of claim 1, wherein the continuous learning module employs online learning techniques and collects user feedback for model improvement.

20. The system of claim 1, wherein the integration module interfaces with various financial management systems through secure APIs and handles large transaction volumes efficiently.
